(19) United States
(12) Patent Application Publication
(10) Pub. No.: US 2025/0342155 A1
(43) Pub. Date: Nov. 6, 2025

(54) DATA ATTRIBUTE RETRIEVAL

(71) Applicant: Capital One Services, LLC, McLean, VA (US)

(72) Inventors: Hong GUO, Glen Allen, VA (US); Gopinath SADHANANTHAM, Frisco, TX (US); Dhanveer SINGH, Glen Allen, VA (US); Sandeep ADHIKARI, Gaithersburg, MD (US); Saji ASOK, Brambleton, VA (US)

(21) Appl. No.: 18/652,376

(22) Filed: May 1, 2024

(51) Int. Cl. G06F 16/2453

(52) U.S. Cl. CPC G06F 16/24539; G06F 16/24532

(57) ABSTRACT

In some implementations, a device may obtain configuration information for a multi-stage process, the configuration information indicating a set of data attributes to be used during the multi-stage process. The device may identify, based on one or more parameters of respective data attributes included in the set of data attributes, one or more data attributes to be obtained prior to a start of the multi-stage process, wherein the one or more parameters are indicated by the configuration information. The device may obtain, via one or more data sources and prior to the start of the multi-stage process, the one or more data attributes. The device may perform, using at least one of the one or more data attributes, one or more stages of the multi-stage process.

### BACKGROUND

In modern information systems, the retrieval of data attributes from different data sources through queries may be part of a data retrieval process for extracting valuable insights from the data. The data retrieval process may involve the formulation of structured queries tailored to the specific schema and characteristics of a given data source. The queries may be transmitted to respective data sources. The data sources may include relational databases, graph databases, application programming interfaces (APIs), and/or structured repositories, among other examples. The data retrieval process may rely on the translation of these queries into optimized execution plans by query processors, which leverage indexing, caching, and optimization techniques to efficiently retrieve and assemble the required attributes. The data retrieval process may be associated with one or more challenges, such as heterogeneity in data formats, distribution across multiple sources, and/or query performance optimization, among other examples.

### SUMMARY

Some implementations described herein relate to a system for data attribute retrieval in a multi-stage process. The system may include one or more memories and one or more processors communicatively coupled to the one or more memories. The one or more processors may be configured to obtain configuration information for the multi-stage process, the configuration information indicating a set of data attributes to be used during the multi-stage process. The one or more processors may be configured to identify, based on one or more parameters of respective data attributes included in the set of data attributes, one or more data attributes to be obtained prior to a start of the multi-stage process, wherein the one or more parameters includes at least one of a data dependency parameter, or a stage parameter. The one or more processors may be configured to obtain, via one or more data sources and prior to the start of the multi-stage process, the one or more data attributes. The one or more processors may be configured to store, in a data cache associated with the multi-stage process, the one or more data attributes. The one or more processors may be configured to perform, using at least one of the one or more data attributes, one or more stages of the multi-stage process.

Some implementations described herein relate to a method for data attribute retrieval. The method may include obtaining, by a device, configuration information for a multi-stage process, the configuration information indicating a set of data attributes to be used during the multi-stage process. The method may include identifying, by the device and based on one or more parameters of respective data attributes included in the set of data attributes, one or more data attributes to be obtained prior to a start of the multi-stage process, wherein the one or more parameters are indicated by the configuration information. The method may include obtaining, by the device and via one or more data sources and prior to the start of the multi-stage process, the one or more data attributes. The method may include performing, by the device and using at least one of the one or more data attributes, one or more stages of the multi-stage process.

Some implementations described herein relate to a non-transitory computer-readable medium that stores a set of instructions. The set of instructions, when executed by one or more processors of a device, may cause the device to identify, based on one or more parameters of respective data attributes included in a set of data attributes associated with a multi-stage process, one or more data attributes to be obtained prior to a start of the multi-stage process, wherein the one or more parameters includes at least one of a data dependency parameter or a stage parameter. The set of instructions, when executed by one or more processors of the device, may cause the device to obtain, via one or more data sources and prior to the start of the multi-stage process, the one or more data attributes. The set of instructions, when executed by one or more processors of the device, may cause the device to perform, using at least one of the one or more data attributes, one or more stages of the multi-stage process.

### BRIEF DESCRIPTION OF THE DRAWINGS

FIGS. 1A-1C are diagrams of an example associated with data attribute retrieval, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with data attribute retrieval, in accordance with some embodiments of the present disclosure.

FIG. 4 is a flowchart of an example process associated with data attribute retrieval, in accordance with some embodiments of the present disclosure.

### DETAILED DESCRIPTION

The following detailed description of example implementations refers to the accompanying drawings. The same reference numbers in different drawings may identify the same or similar elements.

A data attribute may be a descriptor for a data point or a data object. For example, a data attribute may describe other data. A data attribute may be a single value descriptor for a data point or a data object. In some implementations, a data attribute may be associated with using one part of data to describe other parts of the data. A data attribute may be a date (e.g., a given year, month, and/or date), text (e.g., a string of a combination of letters, numbers, and/or other symbols), a string, floating point data (or float data), an integer, and/or a Boolean expression (e.g., for binary data), among other examples. In some implementations, a data attribute may be a data field that represents a characteristic or feature of a data object. For example, for customer data, an attribute may include a customer identifier, an address, and/or a phone number, among other examples. In some implementations, a data attribute may be a data attribute defined for a programming language associated with a database or a data repository. As an example, a data attribute may be defined using a syntax or format associated with a programming language used to obtain, manipulate, create, and/or delete, among other examples, data in a data repository.

In some examples, a device or system may perform a multi-stage process. “Multi-stage process” refers to a process or procedure that includes multiple distinct stages. For example, a multi-stage process may refer to a series of interconnected steps or phases configured to achieve a given outcome or goal. Each stage may involve distinct tasks, operations, and/or transformations, among other examples, that contribute to the overall progression of the process. Throughout each stage of a multi-stage process, there may be dependencies, feedback loops, and/or conditional branching based on intermediate results or external factors, among other examples, which contribute to the complexity and effectiveness of the multi-stage process. A multi-stage process may be configured to use a set of one or more data attributes. For example, each stage may use one or more data attributes, from the set of one or more data attributes, to perform one or more tasks, operations, and/or transformations, among other examples configured for that stage.

For example, during a given stage, a device or system may obtain one or more outputs from previously performed stage(s). The device or system may obtain (e.g., retrieve or fetch) one or more data attributes (e.g., that are configured for use during the given stage) from one or more data sources. The device or system may perform one or more tasks, operations, and/or transformations, among other examples, to generate one or more outputs for the given stage. For example, the device or system may execute one or more rules or perform one or more data transformations (e.g., using the one or more data attributes) to generate the one or more outputs.

For example, data attribute retrieval during the multi-stage process may occur during each stage (e.g., sequentially as the stages are executed or performed). For example, during each stage, a device or system may obtain (e.g., retrieve or fetch) data attribute(s) to be used during that stage prior to performing one or more tasks, operations, and/or transformations, among other examples, using the data attribute(s). However, this manner of data attribute retrieval for a multi-stage process consumes processing resources, and/or network resources, among other examples. Additionally, this manner of data attribute retrieval for a multi-stage process introduces latency or delays into the multi-stage process. For example, data attribute retrieval may be associated with relatively longer delays compared to other parts of the multi-stage process because the data attribute retrieval includes communicating with one or more remote data sources (e.g., remote servers), such as via application programming interface (API) calls, whereas other parts of the multi-stage process (e.g., rule execution and/or data transformation) occurs locally (and is therefore associated with less processing time or delay than the communication(s) with remote data sources).

Some implementations described herein enable efficient data attribute retrieval for a multi-stage process. In some implementations, a data management device may prefetch one or more data attributes prior to the start of the multi-stage process. As used herein, “prefetch” refers to obtaining and/or storing data (e.g., a data attribute) prior to the start of a stage in which the data attribute is to be used. The data management device may prefetch the one or more data attributes based on one or more prefetch eligibility criteria. A prefetch eligibility criterion may define whether a given data attribute is eligible for prefetching for a given multi-stage process. For example, the one or more prefetch eligibility criteria may be based on one or more parameters of a data attribute. The one or more parameters may include a data dependency parameter, and/or a stage parameter, among other examples.

In some implementations, the data dependency parameter may indicate whether a data attribute has unknown values for one or more data dependencies prior to the start of the multi-stage process. In some implementations, the data dependency parameter may indicate whether a data attribute is dependent on an output of at least one stage of the multi-stage process. If a data attribute has an unknown value for a data dependency and/or is dependent on an output of a stage of the multi-stage process, then the one or more prefetch eligibility criteria may indicate that the data attribute is not eligible for prefetching. If a data attribute has no data dependencies and/or has a known (or constant) value for a data dependency, then the one or more prefetch eligibility criteria may indicate that the data attribute is eligible for prefetching. The stage parameter may indicate one or more stage locations of one or more stages, in an order of stages in the multi-stage process, that use a data attribute. The one or more prefetch eligibility criteria may define prefetch eligibility for a data attribute based on a stage location and one or more metrics. The one or more metrics may be associated with obtaining the data attribute. For example, the one or more metrics may include a cost metric, a latency metric, a processing metric (e.g., indicating an amount of processing resources used to obtain the data attribute), an energy metric (e.g., indicating an amount of energy used to obtain the data attribute), among other examples. For example, if the stage location indicates that the data attribute is to be used in a later stage of the multi-stage process and the one or more metrics do not satisfy a prefetch threshold, then the one or more prefetch eligibility criteria may indicate that the data attribute is not eligible for prefetching. If the stage location indicates that the data attribute is to be used in an earlier stage of the multi-stage process and the one or more metrics satisfy the prefetch threshold, then the one or more prefetch eligibility criteria may indicate that the data attribute is eligible for prefetching.

The data management device may obtain configuration information for the multi-stage process, the configuration information indicating a set of data attributes to be used during the multi-stage process. The data management device may identify, based on one or more parameters of respective data attributes included in the set of data attributes, one or more data attributes to be obtained prior to a start of the multi-stage process. The data management device may obtain, via one or more data sources and prior to the start of the multi-stage process, the one or more data attributes. The data management device may store, in a data cache associated with the multi-stage process, the one or more data attributes. The data management device may perform, using at least one of the one or more data attributes, one or more stages of the multi-stage process. For example, if a given stage is configured to use a data attribute that has been prefetched, then the data management device may obtain (e.g., during the given stage) the data attribute from the data cache and may use the data attribute as configured (e.g., by the configuration information) for the given stage.

As a result, the data management device may conserve processing resources, and/or network resources, among other examples, associated with performing the multi-stage process. Additionally, the data management device may reduce the latency and/or delay associated with performing the multi-stage process (e.g., may reduce a total amount of time associated with performing the multi-stage process). For example, by prefetching one or more data attributes in accordance with the one or more prefetch eligibility criteria, a total quantity of communications (e.g., API calls) to remote data sources for the multi-stage process may be reduced. For example, multiple data attributes may be accessible via the data source. By prefetching one or more data attributes in accordance with the one or more prefetch eligibility criteria, a single communication (e.g., a single API call) can be used to obtain the multiple data attributes from the data source. This reduces a delay or latency and/or conserves processing resources, and/or network resources, among other examples, that would have otherwise been associated with obtaining the multiple data attributes via multiple communications (e.g., multiple API calls) that occur during different stages of the multi-stage process.

For example, a multi-stage process may include four stages (e.g., stage 1, stage 2, stage 3, and stage 4). The multi-stage process may be configured to use 10 data attributes from six data sources. For example, a data source 1 may have access to an attribute 1, and attribute 4, and an attribute 7. A data source 2 may have access to an attribute 2 and an attribute 5. A data source 3 may have access to an attribute 3 and an attribute 8. A data source 4 may have access to an attribute 6. A data source 5 may have access to an attribute 9. A data source 5 may have access to an attribute 10. The stage 1 may be configured to use the attribute 1, the attribute 2, and the attribute 3. The stage 2 may be configured to use the attribute 4 and the attribute 5. The stage 3 may be configured to use the attribute 6, the attribute 7, and the attribute 8. The stage 4 may be configured to use the attribute 9 and the attribute 10. The one or more prefetch eligibility criteria may indicate that the attributes 1 through 8 are eligible for prefetching and that the attribute 9 and the attribute 10 are not eligible for prefetching. Previously, the data management device would use ten communications (e.g., ten queries) to obtain the data attributes (e.g., three queries during the stage 1 (to the data source 1, the data source 2, and the data source 3), two queries during the stage 2, three queries during the stage 3, and two queries during the stage 4). Using the techniques and implementations described herein, the data management device may reduce the quantity of communications to obtain the data attributes to six (e.g., six queries) (e.g., four prefetch queries to the data source 1, the data source 2, the data source 3, and the data source 4, and two queries during the stage 4) because during a prefetch operation the data management device may obtain multiple data attributes using a single query (e.g., a single query to the data source 1 can be used to obtain the attribute 1, the attribute 7, and the attribute 8). The reduced quantity of communications may reduce processing resources, network resources, among other examples associated with obtaining the data attributes, thereby improving the overall performance of the data management device and/or the multi-stage process.

Additionally, because the data attributes may be accessible during the multi-stage process from a data cache (e.g., via which a data attribute can be obtained in less amount of time as compared to obtaining the data attribute from a remote data source), an amount of time associated with obtaining the data attributes during the multi-stage process may be reduced. For example, the amount of time associated with obtaining the data attributes during the multi-stage process may be reduced by half or more as compared to obtaining the data attributes separately during each stage (e.g., because of the benefits of the improved performance of the data cache). For example, in the example described above, the total quantity of queries may be reduced by 40% and a total amount of time to obtain the data attributes may be reduced by 100% (e.g., assuming all queries consume the same amount of time).

Additionally, by using the one or more prefetch eligibility criteria, the data management device may ensure that only eligible data attributes are prefetched, thereby conserving processing resources, and/or network resources, among other examples, attempting to obtain a data attribute that has unknown data dependencies, among other examples. Further, by using the stage parameter, the data management device may not prefetch a data attribute that is used in a later stage of the multi-stage process and that is costly to obtain (e.g., in terms of processing resources, energy resources, or monetary resources). For example, depending on a result or output of an earlier stage, the later stage of the multi-stage process may not be performed. Therefore, by using the stage parameter in the prefetch eligibility criteria, the data management device may conserve processing resources, and/or network resources, among other examples, that would have otherwise been used to prefetch a data attribute that may not be used because the stage in which the data attribute is used is not performed or executed (e.g., based on a result or output of an earlier stage).

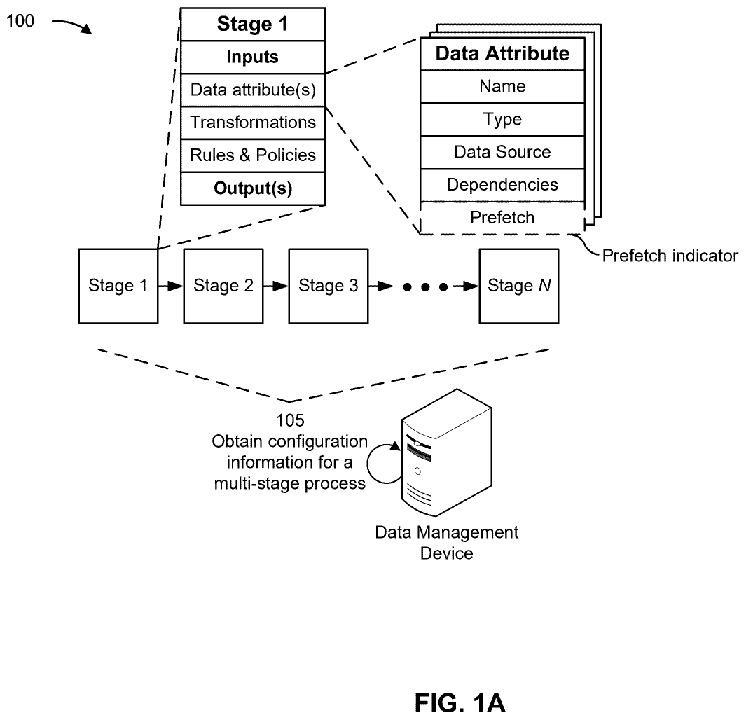

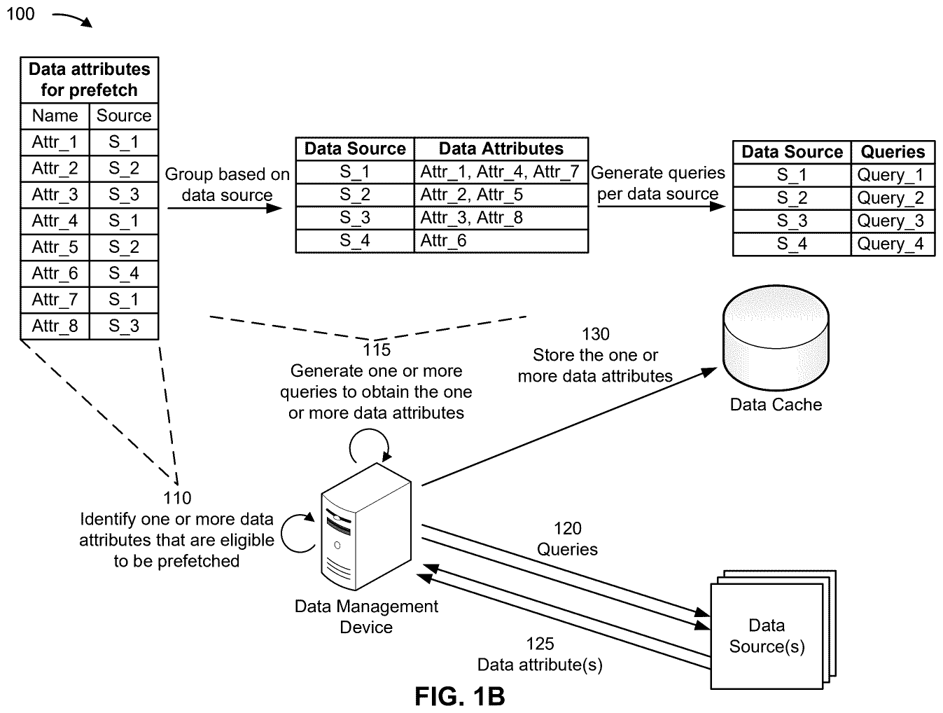

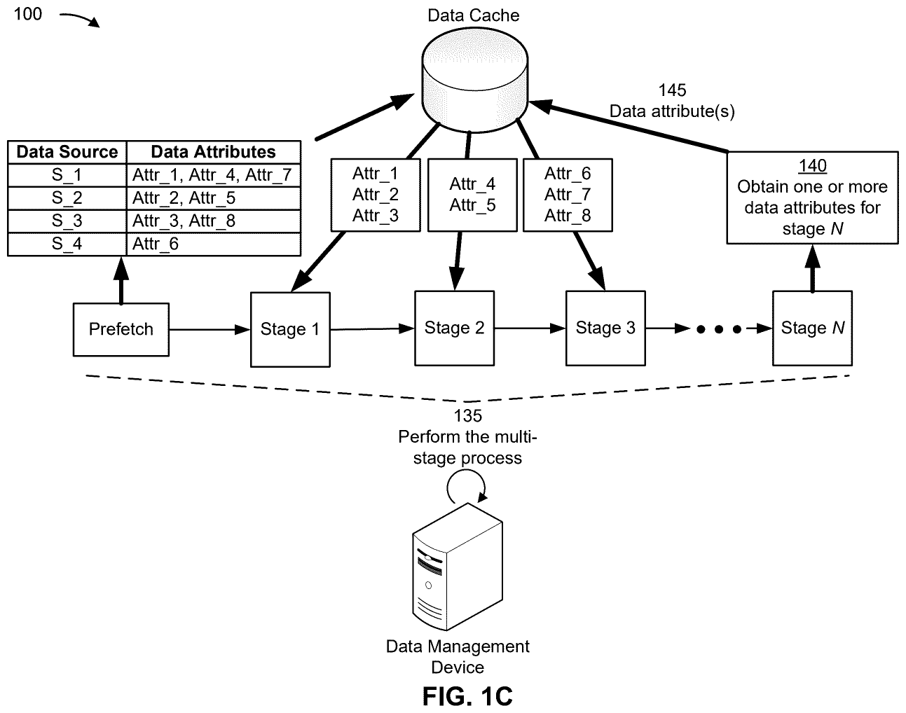

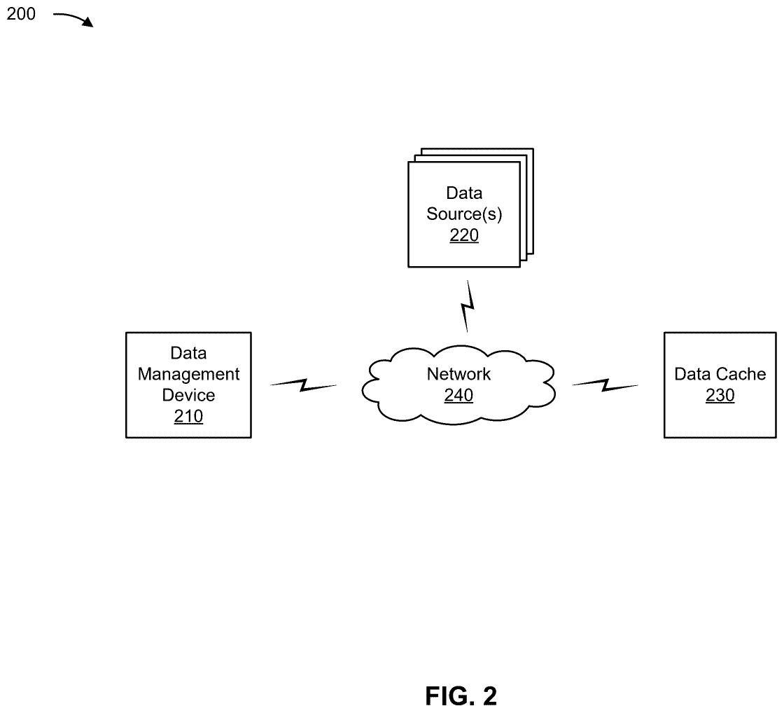

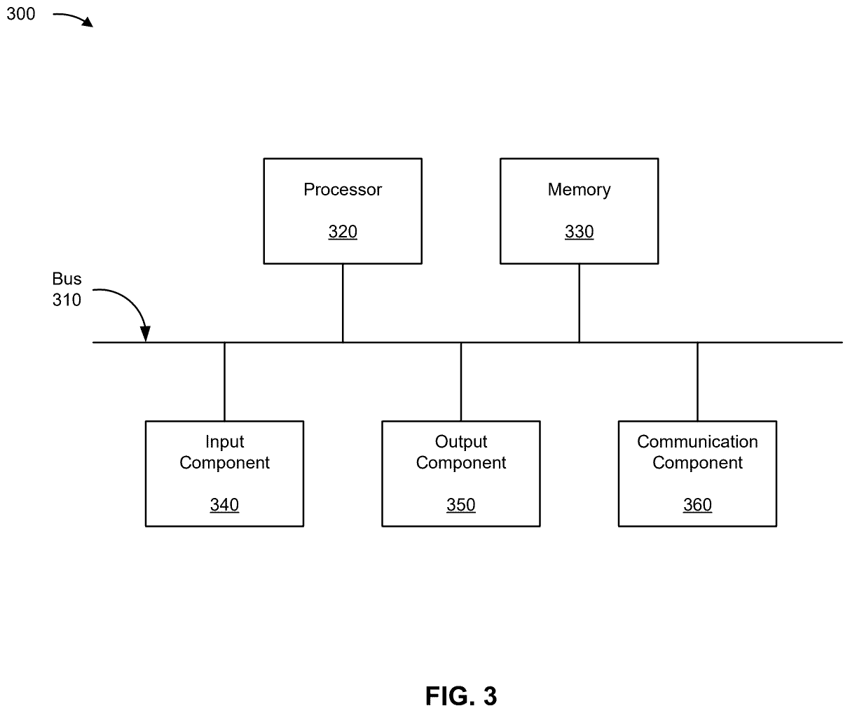

FIGS. 1A-1C are diagrams of an example 100 associated with data attribute retrieval. As shown in FIGS. 1A-1C, example 100 includes a data management device, a data cache, and one or more data sources. These devices are described in more detail in connection with FIGS. 2 and 3.

As shown in FIG. 1A, and by reference number 105, the data management device may obtain configuration information for a multi-stage process. The configuration information for the multi-stage process may configure and/or organize a series of interconnected steps or phases (e.g., stages) to accomplish an objective efficiently and effectively. The configuration information may define an overall goal of the multi-stage process. The configuration information may break down the overall goal into smaller, manageable stages. Each stage may be configured with a set of parameters, inputs, and/or tasks that contribute to the overall progression of the multi-stage process. This configuration information may indicate a sequence in which stages are executed. For example, as shown in FIG. 1A, the configuration information may indicate that the multi-stage process includes a set of one or more stages, shown as a stage 1 through a stage N. The configuration information may indicate an order or sequence in which stages are to be executed or performed, such as a stage 1, followed by a stage 2, followed by a stage 3, and so on until the stage N.

In some implementations, the configuration information may indicate one or more dependencies between stages. For example, the configuration information may indicate which stage is to be performed depending on an output or result of a current stage (e.g., the configuration information may indicate that if an output of stage 1 is a first output, then stage 2 is to be performed following stage 1. Alternatively, the configuration information may indicate that if an output of the stage 1 is a second output, then the stage 3 is to be performed following the stage 1). In some implementations, the configuration information may indicate one or more criteria for transitioning from one stage to the next. In some implementations, the configuration information may indicate one or more parameters, such as resource allocation, concurrency, error handling, and/or data flow, among other examples to optimize performance and reliability.

In some implementations, the configuration information may include configurations for respective stages of the multi-stage process. For example, as shown in FIG. 1A, the configuration information may indicate one or more inputs for a given stage and/or one or more outputs for the given stage (e.g., stage 1 as shown in FIG. 1A). For example, the one or more inputs may indicate one or more data attributes to be used during the given stage, one or more data transformations to be performed during the given stage, and/or one or more rules or policies to be applied or executed during the given stage, among other examples. An output of a given stage may include a value, a parameter, a string, and/or other data or information that is obtained as a result of one or more tasks, operations, and/or data transformations performed during the given stage.

As described elsewhere herein, a data attribute may be a descriptor for a data point or a data object. A data attribute may also be referred to simply as an attribute. A data attribute may describe a characteristic or property of a data entity. For example, in the context of databases and/or data modeling, a data attribute may correspond to a column or field in a table that stores specific types of data (e.g., that are described or indicated by the data attribute). For example, a request for a data attribute may refer to a request for data that is described or indicated by the data attribute. Additionally, obtaining or retrieving a data attribute may refer to obtaining or retrieving data that is described or indicated by the data attribute. For example, a data attribute may be “credit score” and the request for the data attribute may be a request for the data management device to retrieve and/or return a credit score for a particular individual.

As shown in FIG. 1A, the configuration information may include configurations for respective data attributes. A configuration for a given data attribute may indicate a name of the data attribute, a type of the data attribute (e.g., a data type, such as an integer, a string, a float, or another data type), a data source (e.g., via which the data attribute can be obtained), and/or one or more data dependencies of the data attribute, among other examples. For example, a data attribute may be associated with one or more data dependencies. A data dependency may indicate data that is needed to determine, generate, and/or obtain other data. For example, a data dependency for a data attribute may indicate a data input associated with determining, generating, and/or obtaining data described by the data attribute.

In some implementations, the configuration for a given data attribute may include a prefetch indicator. The prefetch indicator may indicate whether the data attribute is eligible for prefetching, as described herein. For example, a data attribute may be marked in the configuration with a Boolean field (e.g., the prefetch indicator) to indicate prefetch eligibility. In some implementations, the data management device may set a value of the prefetch indicator based on determining whether the data attribute is eligible for prefetching, as described in more detail elsewhere herein. In other examples, the value of the prefetch indicator may be indicated by the configuration information (e.g., and set by a user or developer). The data management device may identify, based on the configuration information, whether a prefetch indicator for a data attribute indicates that the data attribute can be obtained prior to the start of the multi-stage process.

As shown in FIG. 1B, and by reference number 110, the data management device may identify one or more data attributes that are eligible to be prefetched (e.g., eligible for prefetching). For example, the configuration information may indicate a set of data attributes to be used during the multi-stage process. The data management device may identify and/or determine one or more data attributes, from the set of data attributes) that are eligible to be prefetched. As described elsewhere herein, prefetching a data attribute may refer to obtaining (e.g., from a data source) and/or storing (e.g., in the data cache) the data attribute prior to an execution of a stage in which the data attribute is used and/or prior to a start of the multi-stage process (e.g., prior to an execution of a first stage of the multi-stage process).

In some implementations, the data management device may identify the one or more data attributes using prefetch indicators in configurations of respective data attributes of the set of data attributes. For example, if a prefetch indicator in a configuration of a given data attribute indicates that the given data attribute is eligible for prefetching, then the data management device may identify or determine that the data attribute is eligible to be prefetched. Alternatively, if the prefetch indicator in the configuration of the given data attribute indicates that the given data attribute is not eligible for prefetching, then the data management device may identify or determine that the data attribute is not eligible to be prefetched.

In some implementations, the data management device may identify the one or more data attributes that are eligible to be prefetched based on one or more prefetch eligibility criteria. A prefetch eligibility criterion may define whether a given data attribute is eligible for prefetching for a given multi-stage process. For example, the one or more prefetch eligibility criteria may be based on one or more parameters of a data attribute. The one or more parameters may include a data dependency parameter, and/or a stage parameter, among other examples.

For example, the data management device may identify that the data dependency parameter for the one or more data attributes indicates that the one or more data attributes (e.g., that are eligible to be protected) do not have unknown values (or have known values) for one or more data dependencies prior to the start of the multi-stage process. In other words, the data management device may determine whether a data attribute is eligible to be prefetched based on whether values or information for each data dependency of the data attribute is available or accessible prior to the start of the multi-stage process. For example, a data dependency of a data attribute may include an output or result of a given stage of the multi-stage process. In such examples, the data management device may determine that the data attribute is not eligible to be prefetched.

Additionally, or alternatively, the data management device may identify whether a data attribute is eligible to be prefetched based on the stage parameter and one or more metrics. For example, the data management device may identify, for the data attribute and based on the stage parameter, one or more stage locations of one or more stages, in an order of stages in the multi-stage process, that use the data attribute. A stage location may indicate where a stage is located in an order or a sequence of the multiple stages in the multi-stage process (e.g., where the order or the sequence is indicated by the configuration information for the multi-stage process). The data management device may determine one or more metrics associated with obtaining the data attribute from a data source via which the data attribute is stored. The one or more metrics may be associated with obtaining the data attribute. For example, the one or more metrics may include a cost metric (e.g., indicating a monetary amount charged to obtain the data attribute), a latency metric (e.g., indicating an amount of time to obtain the data attribute), a processing metric (e.g., indicating an amount of processing resources used to obtain the data attribute), an energy metric (e.g., indicating an amount of energy used to obtain the data attribute), among other examples.

The data management device may determine whether to obtain the data attribute prior to the start of the multi-stage process based on the one or more stage locations and/or the one or more metrics. For example, if the stage parameter indicates that the data attribute is used in a conditional stage (e.g., a stage that is only performed if a certain result or output occurs in a prior stage), then the data management device may determine that the data attribute is not eligible to be prefetched (e.g., because the data attribute may not be needed if the conditional stage is not performed or executed). This conserves processing resources, network resources, and/or memory resources that would have otherwise been used to obtain and store the data attribute in the event that the conditional stage is not performed or executed. As another example, if the one or more metrics indicate that obtaining the data attribute is costly, then the data management device may determine that the data attribute is not eligible to be prefetched. For example, if values of the one or more metrics do not satisfy an eligibility threshold (e.g., are greater than or equal to the eligibility threshold), then the data management device may determine that the data attribute is not eligible to be prefetched.

As another example, the data management device may determine whether to obtain the data attribute prior to the start of the multi-stage process based on a combination of the stage parameter and the one or more metrics. For example, if the stage parameter indicates that the data attribute is used in a stage that occurs later in the order or sequence of the stages (e.g., if a value of the stage location satisfies a location threshold) and values of the one or more metrics do not satisfy an eligibility threshold (e.g., are greater than or equal to the eligibility threshold), then the data management device may determine that the data attribute is not eligible to be prefetched. As another example, if the stage location indicates that the data attribute is used during a stage that occurs after a stage that is configured with a condition that, if met, results in the stage not occurring or being executed and values of the one or more metrics do not satisfy an eligibility threshold (e.g., are greater than or equal to the eligibility threshold), then the data management device may determine that the data attribute is not eligible to be prefetched.

As shown in FIG. 1B, the data management device may identify the one or more data attributes (shown as “Data attributed for prefetch” in FIG. 1B) and data sources via which respective data attributes of the one or more data attributes can be obtained (e.g., retrieved or fetched). As shown by reference number 115, the data management device may generate one or more queries to obtain the one or more data attributes. For example, the data management device may group the one or more data attributes into one or more groups associated with respective data sources of the one or more data sources. For example, the data management device may group the data attributes based on data sources.

For example, as shown in FIG. 1B, the grouping may result in a first group for a first data source (e.g., shown as “S_1”), a second group for a second data source (e.g., shown as “S_2”), a third group for a third data source (e.g., shown as “S_3”), and a fourth group for a fourth data source (e.g., shown as “S_4”). Each group may include one or more data attributes that are accessible and/or that can be obtained via a data source associated with that group. The data management device may generate one or more queries for respective groups of the one or more groups.

For example, the data management device may generate a single query for each group. A query for a group may be generated to obtain the data attributes included in the group. For example, a query (shown as Query_1) for the group associated with the data source S_1 may request a data attribute Attr_1, a data attribute Attr_4, and a data attribute Attr_7 (e.g., as shown in FIG. 1B). As another example, a query (shown as Query_2) for the group associated with the data source S_2 may request a data attribute Attr_2, and a data attribute Attr_5. The data management device may generate queries for each group in a similar manner.

The data management device may obtain, via one or more data sources and prior to the start of the multi-stage process, the one or more data attributes. For example, the data management device may prefetch the one or more data attributes prior to an execution of a first stage of the multi-stage process (e.g., a first stage as indicated by the order or sequence of the multi-stage process). For example, as shown by reference number 120, the data management device may transmit queries to respective data sources. The queries may be, or may be included in, API calls.

For example, the data management device may execute, in parallel, the one or more queries generated as described in connection with reference number 115. The parallel execution of the one or more queries may reduce the latency and/or delay associated with obtaining (e.g., fetching) the one or more data attributes. The data management device may obtain, via the one or more data sources, the one or more data attributes based on executing the one or more queries. For example, as shown by reference number 125, the data sources may transmit, and the data management device may receive, one or more responses indicating the one or more data attributes. For example, a given data source may provide one or more data attributes requested by a query transmitted to the given data source.

As shown by reference number 130, the data management device may store the one or more data attributes in the data cache. For example, the data management device may store, in a data cache associated with the multi-stage process, the one or more data attributes. The data cache may be associated with the multi-stage process in that the data cache may be accessible by components used for executing or performing the stages of the multi-stage process. The data management device may store the data attributes in the data cache for a duration of the multi-stage process.

As shown in FIG. 1C, and by reference number 135, the data management device may perform the multi-stage process (e.g., after prefetching the one or more data attributes). For example, the data management device may perform, using at least one of the one or more data attributes (e.g., the prefetched data attributes), one or more stages of the multi-stage process. For example, the data management device may identify that a stage, of the one or more stages, uses a data attribute of the one or more data attributes that were prefetched. The data management device may obtain, via the data cache, the data attribute. The data management device may perform, during an execution of the stage, one or more actions using the data attribute.

For example, as shown in FIG. 1C, the data attribute Attr_1, the data attribute Attr_2, and the data attribute Attr_3 may be used during the stage 1. The data attribute Attr_1, the data attribute Attr_2, and the data attribute Attr_3 may have been prefetched by the data management device as described in more detail elsewhere herein, such as in connection with FIG. 1B. Therefore, the data management device (or a component performing or executing the stage 1) may obtain the data attribute Attr_1, the data attribute Attr_2, and the data attribute Attr_3 from the data cache (e.g., rather than transmitting a query to one or more data sources). The data management device (or a component performing or executing the stage 1) may perform one or more tasks, apply one or more rules or policies, and/or perform one or more data transformations, among other examples, using the data attribute Attr_1, the data attribute Attr_2, and the data attribute Attr_3 (e.g., to generate one or more outputs of the stage 1). Other stages may use prefetched data attributes in a similar manner.

As a result, the data management device may conserve processing resources, and/or network resources, among other examples, associated with performing the multi-stage process. Additionally, the data management device may reduce the latency and/or delay associated with performing the multi-stage process (e.g., may reduce a total amount of time associated with performing the multi-stage process). For example, by prefetching one or more data attributes in accordance with the one or more prefetch eligibility criteria, a total quantity of communications (e.g., API calls) to remote data sources for the multi-stage process may be reduced. For example, multiple data attributes may be accessible via the data source. By prefetching one or more data attributes in accordance with the one or more prefetch eligibility criteria, a single communication (e.g., a single API call) can be used to obtain the multiple data attributes from the data source. This reduces a delay or latency and/or conserves processing resources, and/or network resources, among other examples, that would have otherwise been associated with obtaining the multiple data attributes via multiple communications (e.g., multiple API calls) that occur during different stages of the multi-stage process.

In some examples, a stage may be configured to use a data attribute that has not been prefetched and/or that is not stored in the data cache. For example, the data management device may identify that a stage, of the one or more stages, uses a data attribute from the set of data attributes that is not included in the one or more data attributes that were prefetched. In such examples, as shown by reference number 140, the data management device may obtain, during an execution of the stage and via a data source associated with the data attribute, the data attribute. For example, during an execution of the stage N, the data management device may obtain one or more data attributes to be used during the stage N that are not currently stored in the data cache. As shown by reference number 145, the data management device may store the data attributes (e.g., obtained during the execution of the stage N) in the data cache.

The data management device (or a component performing or executing the stage 1) may perform, during the execution of the stage (e.g., the stage N), one or more actions using the data attribute (e.g., that was obtained or retrieved during the execution of the stage N). In some cases, the data management device (or a component performing or executing the stage N) may perform, during the execution of the stage (e.g., the stage N), one or more actions using a data attribute obtained from the data cache (e.g., that was prefetched) in addition to using the data attribute that was obtained or retrieved during the execution of the stage N.

As indicated above, FIGS. 1A-1C are provided as an example. Other examples may differ from what is described with regard to FIGS. 1A-1C.

FIG. 2 is a diagram of an example environment 200 in which systems and/or methods described herein may be implemented. As shown in FIG. 2, environment 200 may include a data management device 210, one or more data sources 220, a data cache 230, and a network 240. Devices of environment 200 may interconnect via wired connections, wireless connections, or a combination of wired and wireless connections.

The data management device 210 may include one or more devices capable of receiving, generating, storing, processing, providing, and/or routing information associated with data attribute retrieval, as described elsewhere herein. The data management device 210 may include a communication device and/or a computing device. For example, the data management device 210 may include a server, such as an application server, a client server, a web server, a database server, a host server, a proxy server, a virtual server (e.g., executing on computing hardware), or a server in a cloud computing system. In some implementations, the data management device 210 may include computing hardware used in a cloud computing environment.

A data source 220 may include one or more devices capable of receiving, generating, storing, processing, and/or providing information associated with data attribute retrieval, as described elsewhere herein. The data source 220 may include a communication device and/or a computing device. For example, the data source 220 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data source 220 may communicate with one or more other devices of environment 200, as described elsewhere herein.

The data cache 230 may include one or more devices capable of receiving, generating, storing, processing, and/or providing information associated with data attribute retrieval, as described elsewhere herein. The data cache 230 may include a communication device and/or a computing device. For example, the data cache 230 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the data cache 230 may store retrieved data attributes (such as data attributes that are prefetched for a multi-stage process), as described elsewhere herein.

The network 240 may include one or more wired and/or wireless networks. For example, the network 240 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 240 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with data attribute retrieval. The device 300 may correspond to the data management device 210, a data source 220, and/or the data cache 230. In some implementations, the data management device 210, a data source 220, and/or the data cache 230 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

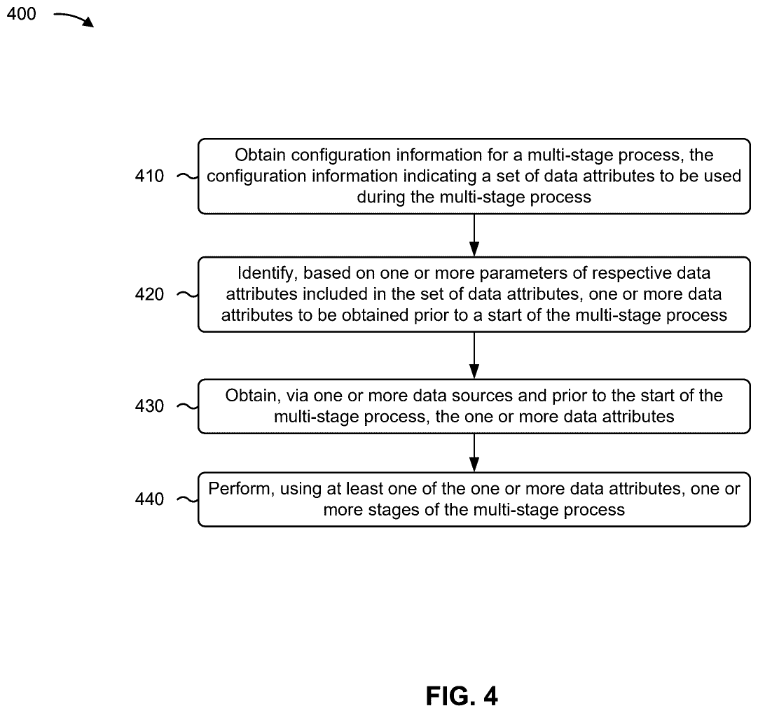

FIG. 4 is a flowchart of an example process 400 associated with data attribute retrieval. In some implementations, one or more process blocks of FIG. 4 may be performed by the data management device 210. In some implementations, one or more process blocks of FIG. 4 may be performed by another device or a group of devices separate from or including the data management device 210, such as one or more data sources 220, and/or the data cache 230, among other examples. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include obtaining configuration information for a multi-stage process, the configuration information indicating a set of data attributes to be used during the multi-stage process (block 410). For example, the data management device 210 (e.g., using processor 320 and/or memory 330) may obtain configuration information for a multi-stage process, the configuration information indicating a set of data attributes to be used during the multi-stage process, as described above in connection with reference number 105 of FIG. 1A. As an example, the configuration information may define an overall goal of the multi-stage process. The configuration information may break down the overall goal into smaller, manageable stages. Each stage may be configured with a set of parameters, inputs, and/or tasks that contribute to the overall progression of the multi-stage process.

As further shown in FIG. 4, process 400 may include identifying, based on one or more parameters of respective data attributes included in the set of data attributes, one or more data attributes to be obtained prior to a start of the multi-stage process (block 420). For example, the data management device 210 (e.g., using processor 320 and/or memory 330) may identify, based on one or more parameters of respective data attributes included in the set of data attributes, one or more data attributes to be obtained prior to a start of the multi-stage process, as described above in connection with reference number 110 of FIG. 1B. In some implementations, the one or more parameters are indicated by the configuration information. The one or more parameters may include a data dependency parameter, a stage parameter, and/or another parameter. For example, the data management device 210 may identify the one or more data attributes that can be prefetched based on data dependencies of the one or more data attributes and/or stage location information of the one or more data attributes, among other examples.

As further shown in FIG. 4, process 400 may include obtaining, via one or more data sources and prior to the start of the multi-stage process, the one or more data attributes (block 430). For example, the data management device 210 (e.g., using processor 320 and/or memory 330) may obtain, via one or more data sources and prior to the start of the multi-stage process, the one or more data attributes, as described above in connection with reference number 125 of FIG. 1B. As an example, the data management device may transmit queries (e.g., API calls) to respective data sources to obtain the one or more data attributes. In some implementations, the data management device 210 may store the one or more data attributes in a data cache, such as the data cache 230.

As further shown in FIG. 4, process 400 may include performing, using at least one of the one or more data attributes, one or more stages of the multi-stage process (block 440). For example, the data management device 210 (e.g., using processor 320 and/or memory 330) may perform, using at least one of the one or more data attributes, one or more stages of the multi-stage process, as described above in connection with reference number 135 of FIG. 1C. As an example, during an execution of a stage, the data management device 210 may obtain a data attribute from the data cache that was prefetched by the data management device 210, as described herein. The data management device 210 may use the data attribute for one or more tasks, operations, and/or transformations, among other examples, during the execution of the stage.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1C. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A system for data attribute retrieval in a multi-stage process, the system comprising:
one or more memories; and
one or more processors, communicatively coupled to the one or more memories, that cause the system to:
obtain configuration information for the multi-stage process, the configuration information indicating a set of data attributes to be used during the multi-stage process,
wherein a data attribute of the set of data attributes is a data field that represents a characteristic of a data object and is defined using a format associated with a programming language, the programming language associated with a data repository;
identify, based on one or more parameters of respective data attributes included in the set of data attributes, multiple data attributes to be obtained prior to a start of the multi-stage process,
wherein the one or more parameters include at least one of:
a data dependency parameter, or
a stage parameter;
execute a single query to obtain the multiple data attributes from one or more data sources prior to the start of the multi-stage process,
wherein the multiple data attributes are eligible to be obtained from the one or more data sources prior to the start of the multi-stage process based on a processing metric satisfying a prefetch threshold, the processing metric indicating an amount of processing resources used to obtain the multiple data attributes, and
wherein the one or more processors, to cause the system to obtain the multiple data attributes, are configured to cause the system to:
group the multiple data attributes into one or more groups associated with the one or more data sources;
generate two or more queries for the one or more groups; and
execute, in parallel, the two or more queries;
store, in a data cache associated with the multi-stage process, the multiple data attributes; and
perform, using at least one of the multiple data attributes, one or more stages of the multi-stage process.

2. The system of claim 1, wherein the data dependency parameter indicates whether the data attribute of the set of data attributes is dependent on an output of at least one stage of the multi-stage process.

3. The system of claim 1, wherein the one or more processors, to identify the multiple data attributes, cause the system to:
identify that the data dependency parameter indicates that the data attribute of the set of data attributes does not have unknown values for one or more data dependencies prior to the start of the multi-stage process.

4. The system of claim 1, wherein the one or more processors, to identify the multiple data attributes, cause the system to:
identify, based on the configuration information, that a prefetch indicator for the data attribute of the set of data attributes indicates that the data attribute is to be obtained prior to the start of the multi-stage process.

5. The system of claim 1, wherein the stage parameter indicates one or more stage locations of the one or more stages, in an order of stages in the multi-stage process, that use the data attribute of the set of data attributes.

6. The system of claim 1, wherein the one or more processors, to identify the multiple data attributes, cause the system to:
identify, for the data attribute of the set of data attributes and based on the stage parameter, one or more stage locations of the one or more stages, in an order of stages in the multi-stage process, that use the data attribute;
determine one or more metrics associated with obtaining the data attribute from a data source via which the data attribute is stored; and
determine whether to obtain the data attribute prior to the start of the multi-stage process based on the one or more stage locations and the one or more metrics.

7. The system of claim 1, wherein the one or more processors, to obtain the multiple data attributes, cause the system to:
obtain, via the one or more data sources, the multiple data attributes based on executing the two or more queries.

8. The system of claim 1, wherein the one or more processors, to perform the one or more stages of the multi-stage process, cause the system to:
identify that a stage, of the one or more stages, uses the data attribute of the set of data attributes;
obtain, via the data cache, the data attribute; and
perform, during an execution of the stage, one or more actions using the data attribute.

9. The system of claim 1, wherein the one or more processors, to perform the one or more stages of the multi-stage process, cause the system to:
identify that a stage, of the one or more stages, uses the data attribute of the set of data attributes, wherein the data attribute of the set of data attributes is not included in the multiple data attributes;
obtain, during an execution of the stage and via a data source associated with the data attribute, the data attribute; and
perform, during the execution of the stage, one or more actions using the data attribute.

10. A method for data attribute retrieval, comprising:
obtaining, by a device, configuration information for a multi-stage process, the configuration information indicating a set of data attributes to be used during the multi-stage process,
wherein a data attribute of the set of data attributes is a data field that represents a characteristic of a data object and is defined using a format associated with a programming language, the programming language associated with a data repository;
identifying, by the device and based on one or more parameters of respective data attributes included in the set of data attributes, multiple data attributes to be obtained prior to a start of the multi-stage process,
wherein the one or more parameters are indicated by the configuration information;
executing, by the device and prior to the start of the multi-stage process, a single query to obtain the multiple data attributes from one or more data sources,
wherein the multiple data attributes are eligible to be obtained from the one or more data sources prior to the start of the multi-stage process based on a processing metric satisfying a prefetch threshold, the processing metric indicating an amount of processing resources used to obtain the multiple data attributes, and
wherein obtaining the multiple data attributes comprises:
grouping the multiple data attributes into one or more groups associated with the one or more data sources;
generating two or more queries for the one or more groups; and
executing, in parallel, the two or more queries; and
performing, by the device and using at least one of the multiple data attributes, one or more stages of the multi-stage process.

11. The method of claim 10, wherein the one or more parameters include at least one of:
a data dependency parameter, or
a stage parameter.

12. The method of claim 10, wherein the one or more parameters indicate whether the data attribute of the set of data attributes, is dependent on an output of at least one stage of the multi-stage process.

13. The method of claim 10, wherein identifying the multiple data attributes comprises:
identifying, based on the configuration information, that a prefetch indicator for the multiple data attributes indicates that the multiple data attributes are to be obtained prior to the start of the multi-stage process.

14. The method of claim 10, wherein identifying the multiple data attributes comprises:
identifying, for the data attribute of the set of data attributes and based on the one or more parameters, one or more stage locations of the one or more stages, in an order of stages in the multi-stage process, that use the data attribute;
determining one or more metrics associated with obtaining the data attribute from a data source via which the data attribute is stored; and
determining whether to obtain the data attribute prior to the start of the multi-stage process based on the one or more stage locations and the one or more metrics.

15. The method of claim 10, wherein obtaining the multiple data attributes comprises:
obtaining, via the one or more data sources, the multiple data attributes based on executing the one or more queries.

16. The method of claim 10, wherein performing the one or more stages of the multi-stage process comprises:
identifying that a stage, of the one or more stages, uses the data attribute of the set of data attributes;
obtaining, via a data cache in which the set of data attributes are stored, the data attribute; and
performing, during an execution of the stage, one or more actions using the data attribute.

17. A non-transitory computer-readable medium storing a set of instructions, the set of instructions comprising:
one or more instructions that, when executed by one or more processors of a device, cause the device to:
identify, based on one or more parameters of respective data attributes of a set of data attributes associated with a multi-stage process, multiple data attributes to be obtained prior to a start of the multi-stage process,
wherein a data attribute of the set of data attributes is a data field that represents a characteristic of a data object and is defined using a format associated with a programming language, the programming language associated with a data repository; and
wherein the one or more parameters include at least one of a data dependency parameter or a stage parameter;
execute, prior to the start of the multi-stage process, a single query to obtain the multiple data attributes from one or more data sources,
wherein the multiple data attributes are eligible to be obtained from the one or more data sources prior to the start of the multi-stage process based on a processing metric satisfying a prefetch threshold, the processing metric indicating an amount of processing resources used to obtain the multiple data attributes, and
wherein the one or more instructions, to cause the device to obtain the multiple data attributes, cause the device to:
group the multiple data attributes into one or more groups associated with the one or more data sources;
generate two or more queries for the one or more groups; and
execute, in parallel, the two or more queries; and
perform, using at least one of the multiple data attributes, one or more stages of the multi-stage process.

18. The non-transitory computer-readable medium of claim 17, wherein the data dependency parameter indicates whether the data attribute of the set of data attributes is dependent on an unknown value prior to the start of the multi-stage process.

19. The non-transitory computer-readable medium of claim 17, wherein the one or more instructions, that cause the device to identify the multiple data attributes, cause the device to:
identify that a prefetch indicator for the multiple data attributes indicates that the multiple data attributes are to be obtained prior to the start of the multi-stage process.

20. The non-transitory computer-readable medium of claim 17, wherein the one or more instructions, that cause the device to obtain the multiple data attributes, cause the device to:
obtain, via the one or more data sources, the multiple data attributes based on executing the one or more queries.
